(19) United States
(12) Patent Application Publication
(10) Pub. No.: US 2002/0042004 A1
(43) Pub. Date: Apr. 11, 2002

(54) Phase contrast variation of a photo-induced refractive material

(76) Inventors: Christian A. Sandstedt, Pasadena, CA (US); Jagdish M. Jethmalani, Pasadena, CA (US); Julia A. Kornfield, Pasadena, CA (US); Robert H. Grubbs, South Pasadena, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/853,885

(22) Filed: May 10, 2001

Related U.S. Application Data
(60) Provisional application No. 60/203,317, filed on May 10, 2000.

(51) Int. Cl. G03H 1/04; G03C 1/73; G03C 5/00

(52) U.S. Cl. 430/2; 430/290; 430/1; 430/945; 430/270.14; 359/3

(57) ABSTRACT

The present invention relates to compositions useful for optically recording or storing data by stimulating a composition having a refraction modulating composition, where a stimulated region of the composition represents one kind of data and a non-stimulated region of the composition represents another kind of data. The present invention also relates to methods of optically recording data utilizing the compositions of the present invention, as well as to optical data storage devices and optical data storage elements which utilize the optical data storage compositions of the invention.

### CROSS-REFERENCE TO RELATED APPLICATIONS

This application is based on U.S. Application No. 60/203,317, filed May 10, 2000, the disclosure of which is incorporated by reference.

### FIELD OF INVENTION

This invention relates generally to photo-induced refractive media for holographic data storage; and more particularly to a photo-induced refractive polymeric composition for use as a high-density storage medium for optically based data storage devices.

### BACKGROUND

Optical systems provide extremely fast and effective means for processing information. In a typical system, an image comprising data is modulated into a coherent light beam. This can be performed by a spatial light modulator placed in the beam. The resulting spatially modulated beam then enters a series of optical elements which filter and process the image, and a detector records the final output. The list of applications for these systems is long, including image and data processing, pattern recognition, optical computation, and high density data storage systems such as holographic data storage systems.

Despite the enormous promise these optical data storage systems hold, finding the optimal material for the application of holography and other optical techniques to data storage is a challenging undertaking, and the quantitative testing and comparison of a variety of different materials continues to make up a significant part of the research effort into optical data storage. There are a number of properties a good optical data storage material should have, including: excellent optical quality, high recording fidelity, high dynamic range, low scattered light, high sensitivity, and non-volatile storage.

For example, with regard to excellent optical quality, a high resolution data page with as many as a million pixels encoding digital data must be imaged through the material and onto the detector array, pixel for pixel. This requires very good homogeneity, and optical quality surfaces.

High recording fidelity is important because the material must faithfully record the data beam amplitude so that this high quality image can be reconstructed when the data is read out.

High dynamic range is important because the larger the amount of data that is recorded in a common volume of material, the weaker each bit of data becomes; the signal strength scales as the inverse square of the amount of data, and is limited ultimately by the ability of the material to respond to optical exposure with the refractive index modulation that records the data. The greater is the materials ability to respond, i.e. the greater its dynamic range, the more data that can be recorded, and ultimately, the greater the density of data that can be stored.

The light scattering properties of the material are important because the ultimate lower limit to the strength of optical materials that are useful for data storage is determined by noise from readout beam scattering. Thus, scattered light also limits storage density.

High sensitivity is likewise important because to store data in the material at a reasonable data rate, the material should respond to the recording beams with high sensitivity.

Finally, non-volatile storage is perhaps of greatest concern because the material must retain the stored data for a time consistent with a data storage application, and should do so in the presence of the light beams used to read the data. For write-once read-many storage, an irreversible material (such as a photopolymer) can be used, which provides stable recording once exposed. If a reversible material is chosen in order to implement erasable/re-writable data storage, the requirement for nonvolatility is in conflict with that for high sensitivity unless a nonlinear writing scheme, such as two-color gated recording is used.

There are several ways to optically store and retrieve information. For example, some of the materials tested for data storage possess refractive components such as monomers which crosslink, while others have mesogens attached to the main chain or side chain polymers, while yet others have photochromic or thermochromic groups attached to the polymer chains. However, the materials which show the most promise for data storage have been photorefractive materials.

The conventional photorefractive effect was first observed in inorganic materials, e.g. barium, titanate and lithium niobate. Since the demonstration of the first organic polymer based photorefractive (PR) system in 1991 by Ducharme et al., this class of materials has been developed to a point where they have now equaled or surpassed many of the performance characteristics of both organic and inorganic photorefractive crystals. See, S. Ducharme, J. C. Scott, R. J. Twieg and W. E. Moerner, Phys. Rev. Lett. 66, 1846 (1991). Together with the low cost and versatility of organic polymer based systems this makes them highly attractive for commercial applications in optical data storage and optical data processing. Recently, a conventional photorefractive polymer has been shown to exhibit 86% steady state diffraction efficiency moving photorefractive polymers further toward implementation. See, e.g., K. Meerholz, B. L. Volodin, Sandalphon, B. Kippelen and N. Peyghambarian, Nature, 371,497 (1994); and B. Kippelen, Sandalphon, N. Peyghambarian, S. R. Lyon, A. B. Padias and H. K. Hall Jr., Electronic. Lett. 29, 1873 (1993). However, several groups have reported this to be a capricious and unstable system which suffers from non-trivial sample preparation, stringent storage requirements (low humidity and dust free environment), and a risk of short device lifetimes. This system has also since been reported by many groups to be extremely difficult to synthesize with good optical quality due to the crystallization of the dye from the matrix. See, e.g., W. E. Moerner, C. Poga, Y. Jia and R. J. Tweig, Organic Thin Films for Photonics Applications (OSA Technical Digest Series), 21, 331 (1995); C. Poga, R. J. Twieg and W. E. Moerner. Organic Thin Films for Photonics Applications (OSA Technical Digest Series), 21,342 (1995); and B. G. Levi, Physics Today, 48,1, 17 (1995). In addition, most conventional holographic data storage media utilize a glassy matrix to disperse the photorefractive monomers. However, in these systems crosslinking of monomers followed by monomer diffusion in a glassy matrix creates volume shrinkage. This is a problem when multiple data is stored at different angles. In an ideal material, then, volume shrinkage of the material would be avoided. In such a circumstance, the first few bits of data stored in the medium lose their resolution due to the shrinkage.

Other examples of prior art optical storage systems and compositions can be found, for example, in U.S. Pat. Nos. 4,172,474; 4,944,112; 5,173,381; 5,470,662; 5,858,585; 5,892,601; 5,920,536; 5,943,145; and 6,046,290. However, each of these systems and compositions contains limitations that make the development of new materials for optical data storage necessary.

Accordingly there is a need in the field of optical data storage for new more efficient, economical and hardy optical data storage materials.

### SUMMARY

The present invention is directed in part to a composition, method and system for recording or storing data by stimulating a composition having a refraction modulating composition dispersed in a polymer matrix wherein the phase contrast is purely the result of the crosslinking of the macromers followed by macromer diffusion, such that there is a null point where the volume shrinkage is overcome by the macromer diffusion. Applicants discovered that since there is a refractive index contrast between the matrix and the macromer, a composition comprising a refraction modulating composition dispersed in a polymer matrix can be stimulated in particular patterns and these patterns can be used for data recording and storage.

Accordingly, in one embodiment the invention is directed to a composition for data storage comprising a first polymer matrix and a refraction modulating composition dispersed therein. Any refraction modulating composition capable of stimulus-induced polymerization can be suitably used, such as photorefractive, photo-induce refractive, photo-addressable, and liquid crystal compositions. In such an embodiment, the stimulated region of the composition represents one kind of data and a non-stimulated region of the composition represents another kind of data.

The invention is also directed to a method of recording data comprising stimulating a composition, wherein the composition comprises a first polymer matrix and a refraction modulating composition dispersed therein wherein the refraction modulating composition is capable of stimulus-induced polymerization, and wherein a stimulated region of the composition represents one kind of data and a non-stimulated region of the composition represents another kind of data.

The invention is also directed to apparatuses for recording or storing data by stimulating a composition having a refraction modulating composition as described above, where a stimulated region of the composition represents one kind of data and a non-stimulated region of the composition represents another kind of data.

### BRIEF DESCRIPTIONS OF THE DRAWINGS

These and other features and advantages of the present invention will be better understood by reference to the following detailed description when considered in conjunction with the accompanying drawings wherein:

FIG. 1a is a schematic of a disk of the present invention being irradiated in the center followed by irradiation of the entire disk to “lock in” the data.

FIG. 1b is a schematic of a disk of the present invention being irradiated in the center followed by irradiation of the entire disk to “lock in” the data.

FIG. 1c is a schematic of a disk of the present invention being irradiated in the center followed by irradiation of the entire disk to “lock in” the data.

FIG. 1d is a schematic of a disk of the present invention being irradiated in the center followed by irradiation of the entire disk to “lock in” the data.

FIG. 2a illustrates the prism irradiation procedure that is used to quantify the refractive index changes after being exposed to various amounts of irradiation.

FIG. 2b illustrates the prism irradiation procedure that is used to quantify the refractive index changes after being exposed to various amounts of irradiation.

FIG. 2c illustrates the prism irradiation procedure that is used to quantify the refractive index changes after being exposed to various amounts of irradiation.

FIG. 2d illustrates the prism irradiation procedure that is used to quantify the refractive index changes after being exposed to various amounts of irradiation.

FIG. 3a shows unfiltered Moiré fringe patterns of an inventive disk of the optical data storage composition. The angle between the two Ronchi rulings was set at 12° and the displacement distance between the first and second Moiré patterns was 4.92 mm.

FIG. 3b shows unfiltered Moiré fringe patterns of an inventive disk of the optical data storage composition. The angle between the two Ronchi rulings was set at 12° and the displacement distance between the first and second Moiré patterns was 4.92 mm.

FIG. 4 is a Ronchigram of an inventive disk of the optical data storage composition. The Ronchi pattern corresponds to a 2.6 mm central region of the disk.

FIG. 5a is a schematic illustrating a second mechanism whereby the formation of the second polymer matrix modulates an optical property by altering the disk shape.

FIG. 5b is a schematic illustrating a second mechanism whereby the formation of the second polymer matrix modulates an optical property by altering the disk shape.

FIG. 5c is a schematic illustrating a second mechanism whereby the formation of the second polymer matrix modulates an optical property by altering the disk shape.

FIG. 5d is a schematic illustrating a second mechanism whereby the formation of the second polymer matrix modulates an optical property by altering the disk shape.

FIG. 6a are Ronchi interferograms of a disk of the optical data storage composition before and after laser treatment.

FIG. 6b are Ronchi interferograms of a disk of the optical data storage composition before and after laser treatment.

FIG. 7 is the corresponding Ronchi interferogram of a photopolymer film in which “CALTECH” and “CVI” were written using the 325 nm line of He:Cd laser.

FIG. 8a is a schematic of an optical data storage apparatus according to the present invention.

FIG. 8b is a schematic of an optical data storage apparatus according to the present invention.

FIG. 8c is a schematic of an optical data storage apparatus according to the present invention.

FIG. 9 is a schematic of a holographic data storage apparatus according to the present invention.

FIG. 10a is a schematic illustrating the operation of a holographic data storage system.

FIG. 10b is a schematic illustrating the operation of a holographic data storage system.

FIG. 10c is a schematic illustrating the operation of a holographic data storage system.

FIG. 10d is a schematic illustrating the operation of a holographic data storage system.

FIG. 11 is a photograph of a section of photopolymerized film.

FIG. 12 is a schematic of a data storage unit according to the present invention.

### DETAILED DESCRIPTION OF THE PREFERRED EMBODIMENTS

The present invention relates to stimulating a composition comprising a refraction modulating composition dispersed in a polymer matrix and using stimulating patterns in data recording and storage.

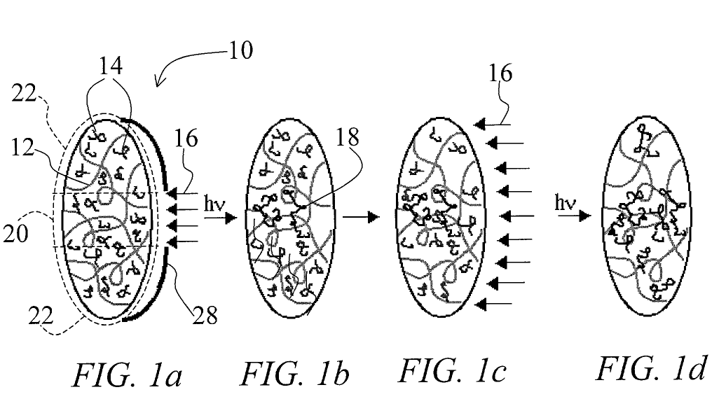

FIGS. 1a to 1d illustrates one inventive embodiment of the current invention in which the refractive index of a particular disk of photo reflective material 10 is changed by light induced polymerization. Once the data is input into the disk 10 as phase contrast variations of the photo reflective material, the data can then be “locked-in” via flood irradiation of the entire disk 10. In the embodiment shown in FIG. 1a, the optical data storage element 10 comprises a first polymer modulating composition (FPMC) 12 having a refraction modulating composition (RMC) 14 dispersed therein. The FPMC 12 forms the optical element framework and is generally responsible for many of its material properties. The RMC 14 may be a single compound or a combination of compounds that is capable of stimulus-induced polymerization, preferably photo-polymerization. As used herein, the term “polymerization” refers to a reaction wherein at least one of the components of the RMC 14 reacts to form at least one covalent or physical bond with either a like component or with a different component. The identities of the FPMC 12 and the RMC 14 will depend on the requirements of the end use data element 10. However, as a general rule, the FPMC 12 and the RMC 14 are selected such that the components that comprise the RMC 14 are capable of diffusion within the FPMC 12, e.g., a loose FPMC 12 will tend to be paired with larger RMC components 14 and a tight FPMC 12 will tend to be paired with smaller RMC 14.

As shown in FIG. 1b, upon exposure to an appropriate energy source 16 (e.g., heat or light), the RMC 14 typically forms a second polymer matrix 18 in the exposed region 20 of the optical data storage element 10. The presence of the second polymer matrix 18 changes the material characteristics of this region 20 of the optical element 10 to modulate its refraction capabilities. In general, the formation of the second polymer matrix 18 typically increases the refractive index of the affected region 20 of the optical data storage element 10.

As shown in FIG. 1c, after exposure, the RMC 14 in the unexposed region 22 will migrate into the exposed region 20 over time. The amount of RMC 14 migration into the exposed region 20 depends upon the frequency, intensity, and duration of the polymerizing stimulus and may be precisely controlled. If enough time is permitted, the RMC 14 will re-equilibrate and redistribute throughout the optical data storage element 10 (i.e., the FPMC 12, including the exposed region). When the region is re-exposed to the energy source 16, the RMC 14 that has since migrated into the region 20 (which may be less than if the RMC 14 were allowed to re-equilibrate) polymerizes to further increase the formation of the second polymer matrix 18. This process (exposure followed by an appropriate time interval to allow for diffusion) may be repeated until the exposed region 20 of the optical data storage element 10 has been sufficiently modified to store the data of interest. The entire data storage element 10 may then be exposed to the energy source 16 to “lock-in” the desired data by polymerizing the remaining RMC 14 that are outside the exposed region 20 before the components 14 can migrate into the exposed region 20, thus forming a read-only optical data storage element 10, as shown in FIG. 1d. Under these conditions, because freely diffusable RMC 14 are no longer available, subsequent exposure of the optical data storage element 10 to an energy source 16 cannot further change its optical properties.

The FPMC 12 is a covalently or physically linked structure that functions as an optical data storage element 10 and is formed from a FPMC 12. In general, the FPMC 12 comprises one or more monomers that upon polymerization will form the FPMC 12. The FPMC 12 optionally may include any number of formulation auxiliaries that modulate the polymerization reaction or improve any property of the data storage element 10. Illustrative examples of suitable FPMC 12 monomers include poly-carbonates, acrylics, methacrylates, phosphazenes, siloxanes, vinyls, homopolymers, and copolymers thereof, and side chain and main chain mesogens, and photochromic and thermochromic moieties, and moieties which undergo a photo-induced cis/trans isomerization, such as, azo-benzene. As used herein, a “monomer” refers to any unit (which may itself either be a homopolymer or copolymer) which may be linked together to form a polymer containing repeating units of the same. If the FPMC monomer 12 is a copolymer, it may be comprised of the same type of monomers (e.g., two different siloxanes) or it may be comprised of different types of monomers (e.g., a siloxane and an acrylic).

In one embodiment, the one or more monomers that form the FPMC 12 are polymerized and cross-linked in the presence of the RMC 14. In another embodiment, polymeric starting material that forms the FPMC 12 is cross-linked in the presence of the RMC 14. Under either scenario, the RMC 14 must be compatible with and not appreciably interfere with the formation of the FPMC 12. Similarly, the formation of the second polymer matrix 18 should also be compatible with the existing FPMC 12, such that the FPMC 12 and the second polymer matrix 18 should not phase separate and light transmission by the optical data storage element 10 should be unaffected.

As described previously, the RMC 14 may be a single component or multiple components so long as: (i) it is compatible with the formation of the FPMC 12; (ii) it remains capable of stimulus-induced polymerization after the formation of the FPMC 12; and (iii) it is freely diffusable within the FPMC 12. In one embodiment, the stimulus-induced polymerization is photo-induced polymerization.

As described above the compositions of the current invention have numerous applications in the electronics and data storage industries. The optical elements also have applications in the medical field, such as being used as medical lenses, particularly as IOL. In such an embodiment, the FPMC 12 and the RMC 14 are as described above with the additional requirement that the resulting materials be biocompatible. Illustrative examples of a suitable biocompatible FPMC 12 include: poly-acrylates such as poly-alkyl acrylates and poly-hydroxyalkyl acrylates; poly-methacrylates such as poly-methyl methacrylate (“PMMA”), poly-hydroxyethyl methacrylate (“PHEMA”), and poly-hydroxypropyl methacrylate (“PHPMA”); poly-vinyls such as poly-styrene and poly-N-vinylpyrrolidone (“PNVP”); poly-siloxanes such as poly-dimethylsiloxane; poly-phosphazenes, and copolymers of thereof. U.S. Pat. No. 4,260,725 and patents and references cited therein (which are all incorporated herein by reference) provide more specific examples of suitable polymers that may be used to form the FPMC 12.

In preferred embodiments, the FPMC 12 generally possesses a relatively low glass transition temperature (“T_{g}”) such that the resulting optical data storage element 10 tends to exhibit fluid-like and/or elastomeric behavior, and is typically formed by crosslinking one or more polymeric starting materials wherein each polymeric starting material includes at least one crosslinkable group. Illustrative examples of suitable crosslinkable groups include but are not limited to hydride, acetoxy, alkoxy, amino, anhydride, aryloxy, carboxy, enoxy, epoxy, halide, isocyano, olefinic, and oxime. In more preferred embodiments, each polymeric starting material includes terminal monomers (also referred to as endcaps) that are either the same or different from the one or more monomers that comprise the polymeric starting material but include at least one crosslinkable group, e.g., such that the terminal monomers begin and end the polymeric starting material and include at least one crosslinkable group as part of its structure. Although it is not necessary for the practice of the present invention, the mechanism for crosslinking the polymeric starting material preferably is different than the mechanism for the stimulus-induced polymerization of the components that comprise the RMC 14. For example, if the RMC 14 is polymerized by photo-induced polymerization, then it is preferred that the polymeric starting materials have crosslinkable groups that are polymerized by any mechanism other than photo-induced polymerization.

An especially preferred class of polymeric starting materials for the formation of the FPMC 12 is poly-siloxanes (also known as “silicones”) endcapped with a terminal monomer which includes a crosslinkable group selected from the group consisting of acetoxy, amino, alkoxy, halide, hydroxy, and mercapto. Because silicone elements tend to be flexible and foldable, the optical data storage elements created thereby will be much less susceptible to damage and data loss. An example of an especially preferred polymeric starting material is bis(diacetoxymethylsilyl)polydimethylsiloxane (which is poly-dimethylsiloxane that is endcapped with a diacetoxymethylsilyl terminal monomer).

The RMC 14 that is used in fabricating optical data storage elements is as described above except that it has the additional requirement of biocompatibility. The RMC 14 is capable of stimulus-induced polymerization and may be a single component or multiple components so long as: (i) it is compatible with the formation of the FPMC 12; (ii) it remains capable of stimulus-induced polymerization after the formation of the FPMC 12; and (iii) it is freely diffusable within the FPMC 12. In general, the same type of monomers that is used to form the FPMC 12 may be used as a component of the RMC 14. However, because of the requirement that the RMC 14 monomers must be diffusable within the FPMC 12, the RMC 14 monomers generally tend to be smaller (i.e., have lower molecular weights) than the monomers which form the FPMC 12. In addition to the one or more monomers, the RMC 14 may include other components such as initiators and sensitizers that facilitate the formation of the second polymer matrix 18.

In preferred embodiments, the stimulus-induced polymerization is photopolymerization. In other words, the one or more monomers that comprise the RMC 14 each preferably includes at least one group that is capable of photopolymerization. Illustrative examples of such photopolymerizable groups include but are not limited to acrylate, allyloxy, cinnamoyl, methacrylate, stibenyl, and vinyl. In more preferred embodiments, the RMC 14 includes a photoinitiator (any compound used to generate free radicals) either alone or in the presence of a sensitizer. Examples of suitable photoinitiators include acetophenones (e.g., a-substituted haloacetophenones, and diethoxyacetophenone); 2,4-dichloromethyl-1,3,5-triazines; benzoin alkyl ethers; and o-benzoyloximino ketone. Examples of suitable sensitizers include p-(dialkylamino)aryl aldehyde; N-alkylindolylidene; and bis [p-(dialkylamino)benzylidene] ketone.

Because of the preference for flexible and foldable optical data storage elements, an especially preferred class of RMC 14 monomers is poly-siloxanes endcapped with a terminal siloxane moiety that includes a photopolymerizable group. An illustrative representation of such a monomer is:

X—Y—X¹

wherein Y is a siloxane which may be a monomer, a homopolymer or a copolymer formed from any number of siloxane units, and X and X¹ may be the same or different and are each independently a terminal siloxane moiety that includes a photopolymerizable group. An illustrative example of Y include:

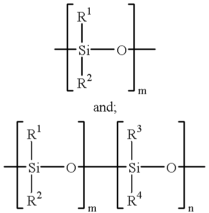

where m and n are independently each an integer and R¹, R², R³, and R⁴ are independently each hydrogen, alkyl (primary, secondary, tertiary, cyclo), aryl, or heteroaryl. In a preferred embodiment, R¹, R², R³, and R⁴are each a C₁-C₁₀ alkyl or phenyl. Because RMC 14 monomers with a relatively high aryl content have been found to produce larger changes in the refractive index of the inventive lens, it is generally preferred that at least one of R¹, R², R³, and R⁴ is an aryl, particularly phenyl. In more preferred embodiments, R¹, R², and R³ are the same and are methyl, ethyl, or propyl and R⁴ is phenyl.

Illustrative examples of X and X¹ (or X¹ and X depending on how the RMC 14 polymer is depicted) are:

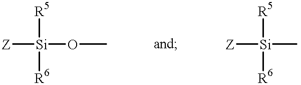

respectively where R⁵ and R⁶ are independently each hydrogen, alkyl, aryl, or heteroaryl; and Z is a photopolymerizable group.

In preferred embodiments, R⁵ and R⁶ are independently each a C₁-C₁₀ alkyl or phenyl and Z is a photopolymerizable group that includes a moiety selected from the group consisting of acrylate, allyloxy, cinnamoyl, methacrylate, stibenyl, and vinyl. In more preferred embodiments, R⁵ and R⁶ are methyl, ethyl, or propyl and Z is a photopolymerizable group that includes an acrylate or methacrylate moiety.

In especially preferred embodiments, an RMC 14 monomer is of the following formula:

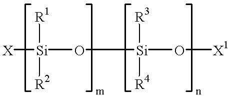

wherein X and X¹ are the same and R¹, R², R³, and R⁴ are as defined previously. Illustrative examples of such RMC 14 monomers include dimethylsiloxane-diphenylsiloxane copolymer endcapped with a vinyl dimethylsilane group; dimethylsiloxane-methylphenylsiloxane copolymer endcapped with a methacryloxypropyl dimethylsilane group; and dimethylsiloxane endcapped with a methacryloxypropyldimethylsilane group.

Although any suitable method may be used, a ring-opening reaction of one or more cyclic siloxanes in the presence of triflic acid has been found to be a particularly efficient method of making one class of inventive RMC 14 monomers. Briefly, the method comprises contacting a cyclic siloxane with a compound of the formula:

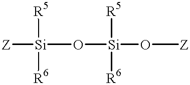

in the presence of triflic acid wherein R⁵, R⁶, and Z are as defined previously. The cyclic siloxane may be a cyclic siloxane monomer, homopolymer, or copolymer. Alternatively, more than one cyclic siloxane may be used. For example, a cyclic dimethylsiloxane tetramer and a cyclic methyl-phenylsiloxane trimer/tetramer are contacted with bis-methacryloxypropyltetramethyldisiloxane in the presence of triflic acid to form a dimethylsiloxane methylphenylsiloxane copolymer that is endcapped with a methacryloxylpropyldimethylsilane group, an especially preferred RMC 14 monomer.

Although primarily photo-induced refractive compounds are discussed above, any refraction modulating composition may be used such as photorefractive, photo-addressable, and liquid crystal compositions The optical data storage elements may be fabricated with any suitable method that results in a FPMC 12 with one or more components which comprise the RMC 14 dispersed therein, and wherein the RMC 14 is capable of stimulus-induced polymerization to form a second polymer matrix 18. In one embodiment, the method comprises mixing a FPMC 12 composition with a RMC 14 to form a reaction mixture; placing the reaction mixture into a mold; polymerizing the FPMC 12 composition to form said optical data storage element 10; and, removing the optical data storage element 10 from the mold.

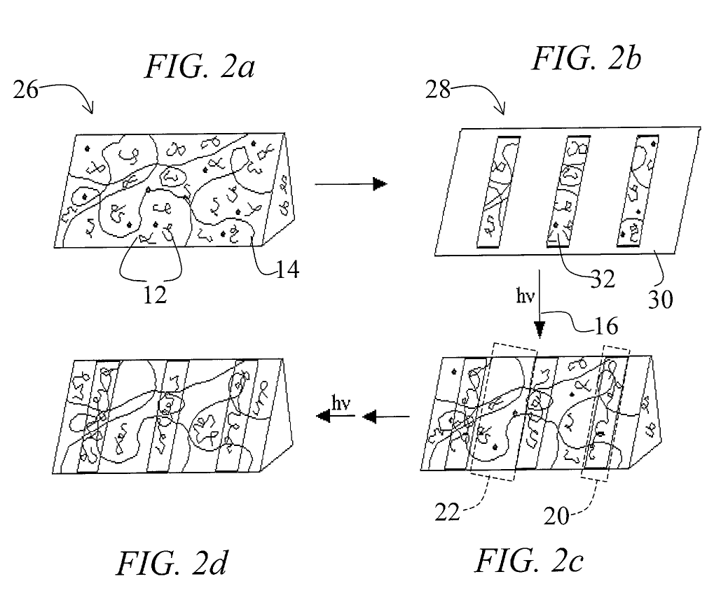

The type of mold that is used will depend on the optical data storage element being made. For example, if the optical data storage element 10 is a prism, as shown in FIGS. 2a to 2d, then a mold in the shape of a prism is used. Similarly, if the optical data storage element 10 is a disk, as shown in FIGS. 1a to 1d, then a disk mold is used and so forth. As described previously, the FPMC 12 composition comprises one or more monomers for forming the FPMC 12 and optionally includes any number of formulation auxiliaries that either modulate the polymerization reaction or improve any property (whether or not related to the optical characteristic) of the optical data storage element 10. Similarly, the RMC 14 comprises one or more components that together are capable of stimulus-induced polymerization to form the second polymer matrix 18. Because flexible and foldable optical data storage elements generally permit more durable elements, it is preferred that both the FPMC 12 composition and the RMC 14 include one or more silicone-based or low T_{g} acrylic monomers.

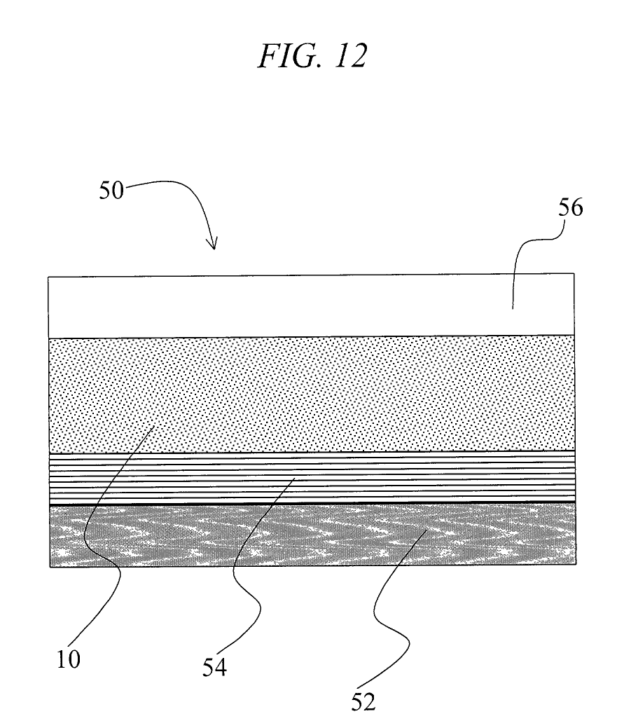

The optical data storage composition 10 can be designed into any suitable conventional data storage device. For example, one data storage device 50 is shown schematically in FIG. 12. In this embodiment the optical data storage device 50 comprises a base material 52 embossed with a tracking layer 54 which serves to assist in the tracking process and provides tracking information. Any suitable material can be utilized for such a base material and tracking layer 54, such as, for example a metallised Mylar sheet or even a separate optical data composition layer on a plastic substrate. In addition, the size and format of the tracks can take any suitable format, such as, for example, in one embodiment the tracks are ANSI and ISO compliant continuous composite format standards. A suitable thickness for such a layer is about 30 μm. The data storage composition 10 is then coated onto the tracking layer 54. Preferably the data storage composition 10 is coated over the tracking layer 54 in a thickness suitable to store single or multiple optical patterns at varying depths. A typical thickness for such a layer is about 50 μm, however any thickness can be used, for example thicker films might be used to allow for the input of larger three-dimensional holographic data. A transparent protective outer layer 56 is then coated over the data storage composition 10 to provide durability. Any other conventional coating layer may be added to the data storage device 50 described above as required by the application. For example, in case a thermal erasure process is utilized, an additional oxide layer may be necessary.

Although one combination of layers is described above with reference to FIG. 12, any suitable device may be constructed such that the data storage composition 10 of the current invention can be controllably exposed to a sufficient stimulus such that data can be imprinted into the data storage composition 10 and such that the data can be reliably recovered therefrom. For example, the data storage unit may be disposed between a pair of conducting electrode layers. The basic optical data storage device described above may be made in any suitable size such that the device will fit into appropriate data read and write apparatuses, such as, for example, a disk, cassette, optical card, CD or DVD.

Optical properties of the optical data storage element 10 as described above can be modified, e.g., by modifying the polymerization of the RMC 14. Such modification can be performed even after data has been stored in the optical data storage element 10 so long as the final lock has not been carried out. For example, any errors in the stored data may be corrected or new data entered in a post data-write procedure. Applicants believe without being bound to any technical limitations that the stimulus-induced polymerization of the RMC forms a second polymer matrix 18 which can change the refractive index of the optical data storage element in a predictable manner, thus affecting a readable change in the optical data storage element phase contrast.

Induction of polymerization of the RMC 14 of an optical data storage element 10 can be achieved by exposing the optical data storage element 10 to a stimulus 16. In general, a method of inducing polymerization of an optical data storage element 10 having a FPMC 12 and a RMC 14 dispersed therein, comprises:

(a) exposing at least a portion of the optical data storage element 10 to a stimulus 16 whereby the stimulus 16 induces the polymerization of the RMC 14. If after initial data storage no data needs to be modified, then the exposed portion is the entire optical data storage element 10. The exposure of the entire optical data storage element 10 with intensity sufficient to induce complete polymerization of the RMC throughout the optical data storage element 10 will lock in the then-existing properties of the optical data storage element 10.

However, if data needs to be modified, then specific areas of the optical data storage element 10 must be re-exposed to the stimulus 16. Such differential polymerization of the RMC 14 can be achieved via any suitable means of changing the intensity of the stimulus 16 spatially across the optical data storage element 10, such as, for example, by exposing only a portion of the optical data storage element 10 to the stimulus 16 via a photomask and collimated beam; or alternatively by utilizing a stimulus source capable of variable intensity across the entire area of the optical data storage elements 10, such that the optical data storage element 10 is subject to a spatially variable stimulus. In one embodiment, the method of implementing the optical data storage element 10 further comprises:

(b) waiting an interval of time to allow macromer diffusion; and

(c) re-exposing a portion of the optical data storage element 10 to the stimulus 16.

This procedure generally will induce the further polymerization of the RMC 14 within the exposed data storage region 20. Steps (b) and (c) may be repeated any number of times until the data has been stored. The waiting period is important to establish a null point where the volume shrinkage usually seen in photo-induced polymers is overcome by macromer diffusion. At this point, the method may further include the step of exposing the entire optical data storage element 10 to the stimulus 16 to lock-in the desired data.

Induction of the polymerization of the RMC in an optical data storage element 10 can also be achieved by:

(a) exposing a first portion of the optical data storage element 10 to a stimulus 16 whereby the stimulus 16 induces the polymerization of the RMC 14; and

(b) exposing a second portion of the optical data storage element 10 to the stimulus 16.

The first optical data storage portion and the second optical data storage portion represent different regions of the optical data storage element 10 although they may overlap. Optionally, the method may include an interval of time between the exposures of the first optical data storage portion and the second optical data storage portion. In addition, the method may further comprise re-exposing the first optical data storage portion and/or the second optical data storage portion any number of times (with or without an interval of time between exposures) or may further comprise exposing additional portions of the optical data storage element 10 (e.g., a third optical data storage portion, a fourth optical data storage portion, etc.). Once the desired data has been stored, then the method may further include the step of exposing the entire optical data storage element 10 to the stimulus 16 to lock-in the desired data.

In general, the location of the one or more exposed portions 20 will vary depending on the amount of data being stored. For example, in one embodiment, the exposed portion 20 of the optical data storage element 10 is the center region of the optical data storage element 10 (e.g., between about 4 mm and about 5 mm in diameter). Alternatively, the one or more exposed optical data storage portions 20 may be along the optical data storage element's 10 outer rim or along a particular meridian. A stimulus 16 for induction of polymerization of the RMC 14 can be any appropriate coherent or incoherent light source.

The stored data itself can be in any known high or low resolution format, such as for example where the exposed or stimulated region represents a digital “1” and the non-exposed or non-stimulated region represents a digital “0”; or where the data is stored in an analog or holographic format.

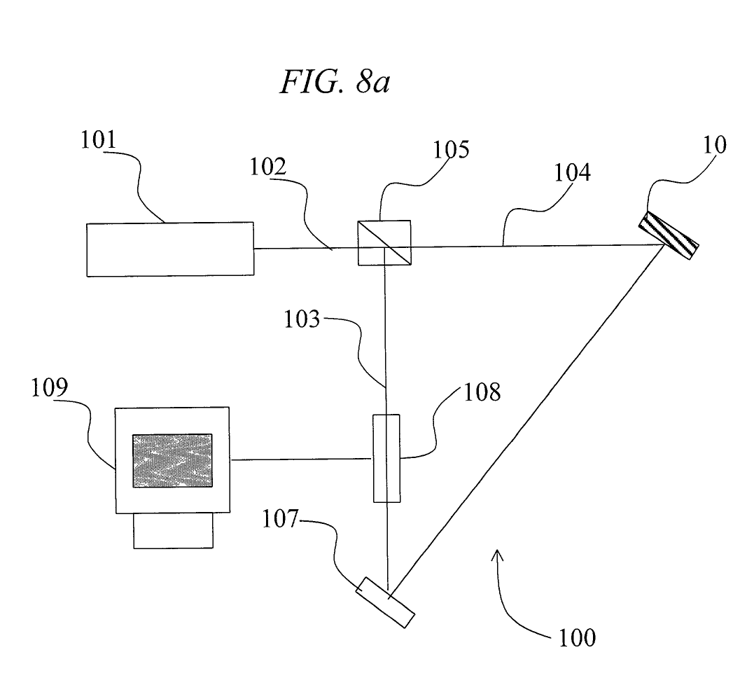

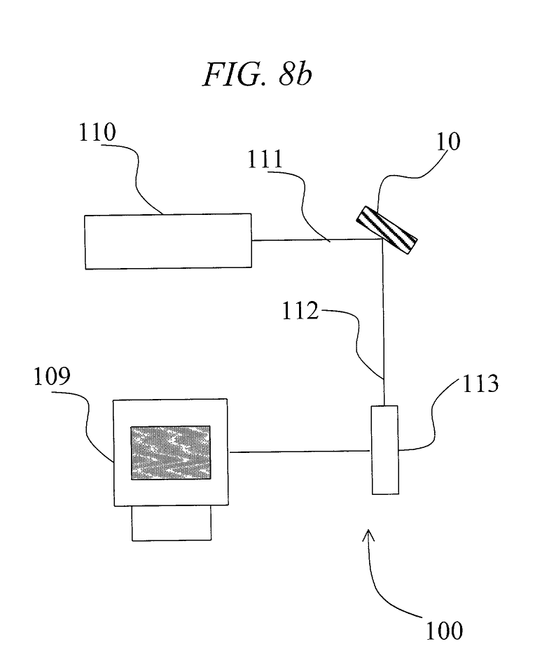

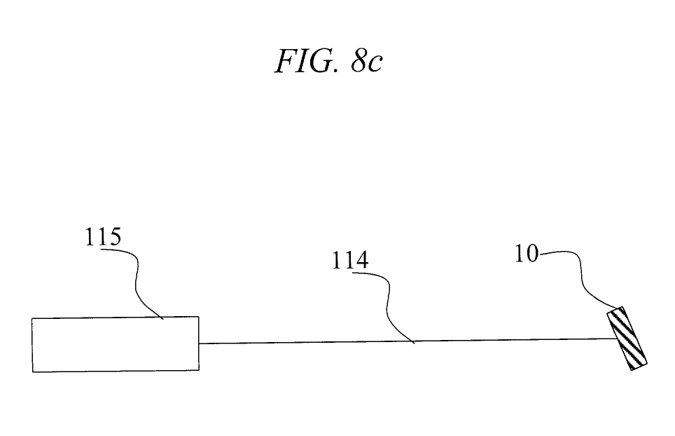

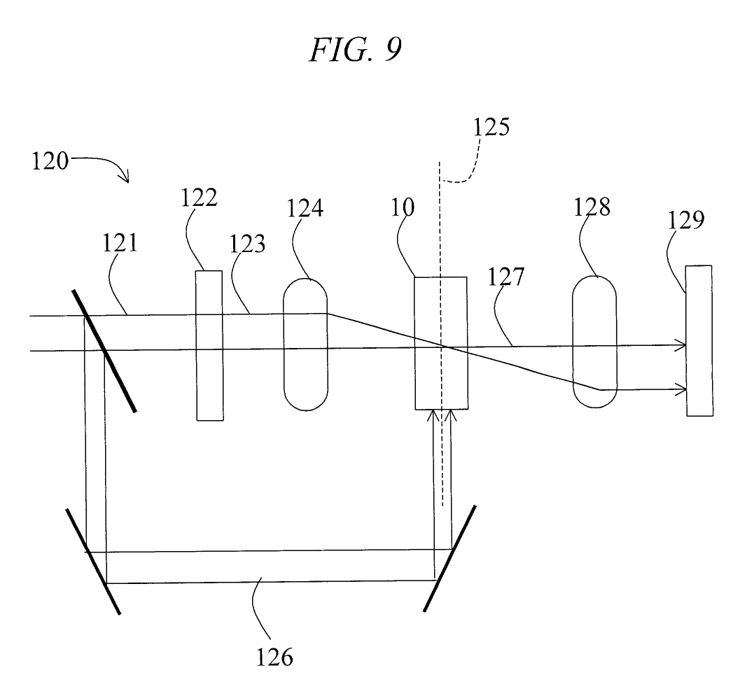

Referring to FIG. 8a, there is shown a conventional data storage system 100 for an optical recording in an optical storage medium 10. A source of light 101 provides a beam 102 of collimated incoherent or coherent radiation, such as from a laser for example. The beam 102 is split into a writing beam 103 and a reference beam 104 by beamsplitter 105. The reference 104 and writing 103 beams interfere at the optical storage medium 10. A mirror 107 is normally required to redirect one of the beams 103 or 104 to the optical storage medium 10.

A modulation can be placed on the writing beam 103 by modulator 108. The modulator 108 may be electrooptic or acoustooptic and may modulate one or more of the phase, amplitude and polarization of the beam 103. A computer 109 is typically used to control the operation of the modulator 108 in a known way so as to encode the beam 103 with desired information which is subsequently stored in the optical storage medium 10.

The stored information is retrieved from the optical storage medium 10 by the arrangement shown in FIG. 8b. The optical storage medium 10 is illuminated by a light source 110 with a beam 111. Typically, the light source 110 has a different wavelength to the writing light source 101. Since the reading and writing is occurring at different wavelengths the incident angle of the respective beams with the optical storage medium will be different and set by the Bragg relation. A reflected beam 112 impinges a detector 113 which supplies signals to, typically, the computer 109 for analysis to decode the encoded information.

The information stored in the optical storage medium 10 can be erased by irradiation with a beam 114 from a light source 115 operating at a different wavelength, as depicted in FIG. 8c.

The procedure described above may be repeated as many times as necessary, such that after the write beam 104 has entered the desired data, and sufficient time has been allowed for a change in the optical properties of the optical data storage element 10, any data aberrations could be detected by the data read beam 110 and another beam 104, whose beam characteristics depend on the second set of data may be applied. This process of write/read/re-write may be continued until the desired data is stored or until the optical data storage element 10 is photo-locked.

It should be noted that any suitable light source 101, beam splitter 105, mirror 107, modulator 108, computer 109, and detector 113 may be used in the current invention such that the data can be stored within the optical data storage element 10 and the data read, analyzed and, if necessary, corrected.

For example, the source of light 101 for the write/read/erase cycles could be any suitable light source, such as, for example, a UV light for high resolution data and IR light for low resolution data, or a coherent or incoherent visible light source, such as, a frequency doubled diode laser, a diode laser, or a helium neon laser. The computer and control means may conveniently be embodied in a personal computer. By way of example the approximate power densities required and achievable are 5-10 mW/cm² at 490 nm for writing, 5 mW/cm² at 780 nm for reading and 10 mW/cm² at 635 nm for erasing. It will also be appreciated that erasure may be effected thermally or by an electric field. In these cases the application of the thermal or electric energy is controlled by the control means. The choice of optical, thermal or electric erasure is dependent on the storage medium of the optical storage means.

Although one very general optical storage system is described above with regard to FIGS. 8a to 8c, any conventional optical data storage system can be utilized with the current data storage composition. For example a holographic data storage system 120 using Fourier hologram recordings could be utilized, as depicted schematically in FIG. 9. In such a system, a collimated laser beam 121 is directed through a spatial light modulator (SLM) 122 which impresses into the beam 121 the desired optical data 123 to be stored in the system. The spatially modulated output 123 of the SLM 122 is directed towards a positive lens 124. The SLM 122 is located at a front focal plane of the lens 124, while the optical data storage element 10, is located at a back focal plane 125. It is well known that after passing through the lens 124 and arriving at the optical data storage element 10, the modulated beam 121 generates the spatial Fourier transform of the original data 123 (see, for example, J. W. Goodman, Introduction to Fourier Optics, McGraw-Hill, 1968, incorporated herein by reference). Hence, a volume hologram is formed in the data storage device 10 by the interference of the modulated beam 121 with a reference laser beam 126 directed orthogonal to the write beam 121 and into the optical data storage element 10.

In such a system, once the hologram is created, the original signal can be retrieved by directing the reference beam 126 into the data storage element 10. However, the reconstructed beam 127 initially contains the transformed data not the original data. To render the optical data in its original form produced by the SLM 122, the reconstructed beam 127 must be focused by a lens 128, referred to hereafter as a readout lens. Generally, the readout lens 128 focuses the beam 127 on the surface of a spatial light detector 129, most commonly a charge coupled device (CCD). The resulting image is that of the original data and is consequently recovered by the detector 129.

Although a 4-focal length (4-f) Fourier holography arrangement has traditionally been used for holographic data storage any suitable arrangement may be utilized. As an example, in a 4-f system, a spatial light modulator 122 is placed at the front focal plane of a first lens 124 and the optical data storage element 10 is placed at the back focal plane 125 (the Fourier plane) of the first lens 124. A second lens 128 is placed after the medium at a distance from the first lens 124 equal to the sum of the focal lengths of the first 124 and second lens 128, and a detector array 129 is placed at the back focal plane of the second lens 128. Each pixel imaged on the detector array 129 is recorded throughout the optical data storage element 10. The device 120 is therefore less susceptible to error than a device which records data only at an image plane.

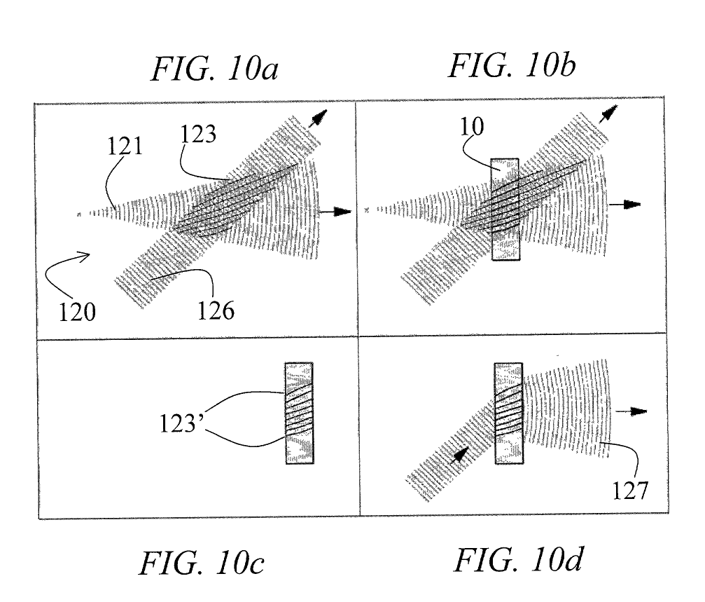

As described above, the usual holographic data recording process involves the interference of two light beams on the data storage composition 10. It is accomplished by combining an image-bearing light beam and a reference beam in the data storage composition 10. The variation in intensity in the resulting interference pattern causes the complex index of refraction to be modulated throughout the volume of the medium. FIGS. 10a to 10d schematically illustrate the operation of a holographic data storage system according to that shown in FIG. 9. During operation two beams, a data beam 121 and a reference beam 126 converge at a focal plane 125 creating a static interference pattern corresponding to the data 123, as shown in FIG. 10a. The data storage device 10 containing the data storage composition is placed in the center of the interference pattern 123, as shown in FIG. 10b, such that the data 123 pattern is imprinted on the data storage composition 10 in the form of a change in refractivity, absorption, or thickness of the material 123′, as shown in FIG. 10c. To read the data light from the reference beam 126 is directed at the surface of the composition 10 and the beam 126 interacts with the pattern 123′ to generate a reconstructed data beam 127 which can then be detected, processed and reported to a user, as shown in FIG. 10d. Using such a process any suitable holograph can be created, such as, for example, a reflective or volume hologram.

Although above we have described the operation of two potential data storage systems 100 and 120 utilizing the data storage composition 10 of the current invention, it should be understood that any data storage system could be utilized such that sufficient stimulus is provided to initiate polymerization of the data storage element 10, including the use of a simple shadow mask, as described in detail in Example 13, below.

The following examples are provided for purposes of exemplifying the invention and showing its utility only and are not intended to limit the scope of the invention which has been described in broad terms above.

### EXAMPLE 1

Suitable optical data storage materials comprising various amounts of (a) poly-dimethylsiloxane endcapped with diacetoxymethylsilane (“PDMS”) (36000 g/mol), (b) dimethylsiloxane-diphenylsiloxane copolymer endcapped with vinyl-dimethyl silane (“DMDPS”) (15,500 g/mol), and (c) a UV-photoinitiator, 2,2-dimethoxy-2-phenylacetophenone (“DMPA”) as shown by Table 1 were made and tested. PDMS is the monomer which forms FPMC, and DMDPS and DMPA together comprise the RMC.

Appropriate amounts of PMDS (Gelest DMS-D33; 36000 g/mol), DMDPS (Gelest PDV-0325; 3.0-3.5 mole % diphenyl, 15,500 g/mol), and DMPA (Acros; 1.5 wt % with respect to DMDPS) were weighed together in an aluminum pan, manually mixed at room temperature until the DMPA dissolved, and degassed under pressure (5 mtorr) for 2-4 minutes to remove air bubbles. Photosensitive prisms, as shown schematically in FIGS. 2a to 2d, were fabricated by pouring the resulting silicone composition into a mold made of three glass slides held together by scotch tape in the form of a prism and sealed at one end with silicone caulk. The prisms are ˜5 cm long and the dimensions of the three sides are ˜8 mm each. The PDMS in the prisms was moisture cured and stored in the dark at room temperature for a period of 7 days to ensure that the resulting FPMC was non-tacky, clear, and transparent.

TABLE 1

| | | | D M P A |
|---|---|---|---|
| | PDMS (wt %) | DMDPS (wt %) | (wt %)^{a} |
| 1 | 90 | 10 | 1.5 |
| 2 | 80 | 20 | 1.5 |
| 3 | 75 | 25 | 1.5 |
| 4 | 70 | 30 | 1.5 |

^{a}wt % with respect to DMDPS.

The amount of photoinitiator (1.5 wt %) was based on prior experiments with fixed RMC monomer content of 25% in which the photoinitiator content was varied. Maximal refractive index modulation was observed for compositions containing 1.5 wt % and 2 wt % photoinitiator while saturation in refractive index occurred at 5 wt %.

### EXAMPLE 2

Synthesis of RMC Monomers

As illustrated by Scheme 1, below, commercially available bis-methacryloxylpropyltetramethyl-disiloxane (“MPS”) dissociates and then ring-opens the commercially available octamethylcyclotetrasiloxane (“D₄”) and trimethyltriphenylcyclotrisiloxane (“D3′”) in the presence of triflic acid in a one pot synthesis to form linear RMC monomers.

The entire synthesis is described in U.S. Pat. No. 4,260,725; Kunzler, J. F., Trends in Polymer Science, 4: 52-59 (1996); Kunzler et al. J. Appl. Poly. Sci., 55: 611-619 (1995); and Lai et al., J. Poly. Sci. A. Poly. Chem., 33: 1773-1782 (1995), incorporated herein by reference.

[chemical structure]

Appropriate amounts of MPS, D₄, and D₃′ were stirred in a vial for 1.5-2 hours. An appropriate amount of triflic acid was added and the resulting mixture was stirred for another 20 hours at room temperature. The reaction mixture was diluted with hexane, neutralized (the acid) by the addition of sodium bicarbonate, and dried by the addition of anhydrous sodium sulfate. After filtration and rotovaporation of hexane, the RMC monomer was purified by further filtration through an activated carbon column. The RMC monomer was dried at 5 mtorr of pressure between 70-80° C. for 12-18 hours.

The amounts of phenyl, methyl, and endgroup incorporation were calculated from ¹H-NMR spectra that were run in deuterated chloroform without internal standard tetramethylsilane (“TMS”). Illustrative examples of chemical shifts for some of the synthesized RMC monomers follows. A 1000 g/mole RMC monomer containing 5.58 mole % phenyl (made by reacting: 4.85 g (12.5 mmole) of MPS; 1.68 g (4.1 mmole) of D₃′; 5.98 g (20.2 mmole) of D₄; and 108 ml (1.21 mmole) of triflic acid: d=7.56-7.57 ppm (m, 2H) aromatic, d=7.32-7.33 ppm (m, 3H) aromatic, d=6.09 ppm (d, 2H) olefinic, d=5.53 ppm (d, 2H) olefinic, d=4.07-4.10 ppm (t, 4H)—O—CH₂CH₂CH₂—, d=1.93 ppm (s, 6H) methyl of methacrylate, d=1.65-1.71 ppm (m, 4H)—O—CH₂CH₂CH₂—, d=0.54-0.58 ppm (m, 4H)—O—CH₂CH₂CH₂—Si, d=0.29-0.30 ppm (d, 3H), CH₃—Si-Phenyl, d=0.04-0.08 ppm (s, 50 H) (CH₃)₂Si of the backbone.

A 2000 g/mole RMC monomer containing 5.26 mole % phenyl (made by reacting: 2.32 g (6.0 mmole) of MPS; 1.94 g (4.7 mmole) of D₃′; 7.74 g (26.1 mmole) of D₄; and 136 ml (1.54 mmole) of triflic acid: d=7.54-7.58 ppm (m, 4H) aromatic, d=7.32-7.34 ppm (m, 6H) aromatic, d=6.09 ppm (d, 2H) olefinic, d=5.53 ppm (d, 2H) olefinic, d=4.08-4.11 ppm (t, 4H)—O—CH₂CH₂CH₂—, d=1.94 ppm (s, 6H) methyl of methacrylate, d=1.67-1.71 ppm (m, 4H)—O—CH₂CH₂CH₂—, d=0.54-0.59 ppm (m, 4H)—O—CH₂CH₂CH₂—Si, d=0.29-0.31 ppm (m, 6H), CH₃—Si-Phenyl, d=0.04-0.09 ppm (s, 112H) (CH₃)₂Si of the backbone.

A 4000 g/mole RMC monomer containing 4.16 mole % phenyl (made by reacting: 1.06 g (2.74 mmole) of MPS; 1.67 g (4.1 mmole) of D₃′; 9.28 g (31.3 mmole) of D4; and 157 ml (1.77 mmole) of triflic acid: d=7.57-7.60 ppm (m, 8H) aromatic, d=7.32-7.34 ppm (m, 12H) aromatic, d=6.10 ppm (d, 2H) olefinic, d=5.54 ppm (d, 2H) olefinic, d=4.08-4.12 ppm (t, 4H)—O—CH₂CH₂CH₂—, d=1.94 ppm (s, 6H) methyl of methacrylate, d=1.65-1.74 ppm (m, 4H)—O—CH₂CH₂CH₂—, d=0.55-0.59 ppm (m, 4H)—O—CH₂CH₂CH₂—Si, d=0.31 ppm (m, 11H), CH₃—Si-Phenyl, d=0.07-0.09 ppm (s, 272 H) (CH₃)₂Si of the backbone.

Similarly, to synthesize dimethylsiloxane polymer without any methylphenylsiloxane units and endcapped with methyacryloxypropyldimethylsilane, the ratio of D₄ to MPS was varied without incorporating D′₃.

Molecular weights were calculated by ¹H-NMR and by gel permeation chromatography (“GPC”). Absolute molecular weights were obtained by universal calibration method using polystyrene and poly(methyl methacrylate) standards. Table 2 shows the characterization of other RMC monomers synthesized by the triflic acid ring opening polymerization.

TABLE 2

| | Mole % | Mole % | Mole % | M n | M n | |
|---|---|---|---|---|---|---|
| | Phenyl | Methyl | Methacrylate | (NMR) | (GPC) | n_{D} |
| A | 6.17 | 87.5 | 6.32 | 1001 | 946 | 1.44061 |
| B | 3.04 | 90.8 | 6.16 | 985 | 716 | 1.43188 |
| C | 5.26 | 92.1 | 2.62 | 1906 | 1880 | — |
| D | 4.16 | 94.8 | 1.06 | 4054 | 4200 | 1.42427 |
| E | 0 | 94.17 | 5.83 | 987 | 1020 | 1.42272 |
| F | 0 | 98.88 | 1.12 | 3661 | 4300 | 1.40843 |

At 10-40 wt %, these RMC monomers of molecular weights 1000 to 4000 g/mol with 3-6.2 mole % phenyl content are completely miscible, biocompatible, and form optically clear prisms and disks when incorporated in the silicone matrix. RMC monomers with high phenyl content (4-6 mole %) and low molecular weight (1000-4000 g/mol) resulted in increases in refractive index change of 2.5 times and increases in speeds of diffusion of 3.5 to 5.0 times compared to the RMC monomer used in Table 1 (dimethylsiloxane-diphenylsiloxane copolymer endcapped with vinyldimethyl silane (“DMDPS”) (3-3.5 mole % diphenyl content, 15500 g/mol). These RMC monomers were used to make optical elements comprising: (a) polydimethylsiloxane endcapped with diacetoxymethylsilane (“PDMS”) (36000 g/mol), (b) dimethylsiloxane methylphenylsiloxane copolymer that is endcapped with a methacryloxylpropyldimethylsilane group, and (c) 2,2-dimethoxy-2-phenylacetophenone (“DMPA”). Note that component (a) is the monomer that forms the FPMC and components (b) and (c) comprise the RMC.

### EXAMPLE 3

Fabrication of Lense Disk Data Storage Elements

In another experiment a lense shaped disk mold was designed according to well-accepted standards. See e.g., U.S. Pat. Nos. 5,762,836; 5,141,678; and 5,213,825. Briefly, the mold is built around two plano-concave surfaces possessing radii of curvatures of −6.46 mm and/or −12.92 mm, respectively. The resulting lense disks are 6.35 mm in diameter and possess a thickness ranging from 0.64 mm, 0.98 mm, or 1.32 mm depending upon the combination of concave surfaces used. Using two different radii of curvatures in their three possible combinations and assuming a nominal refractive index of 1.404, but not limited to, for the disk composition, disks with pre-irradiation powers of 10.51 D (62.09 D in air), 15.75 D (92.44 in air), and 20.95 D (121.46 D in air) were fabricated.

### EXAMPLE 4

Stability of Compositions Against Leaching

Three test lense disks were fabricated with 30 and 10 wt % of RMC monomers B and D incorporated in 60 wt % of the PDMS matrix. After moisture curing of PDMS to form the FPMC, the presence of any free RMC monomer in the aqueous solution was analyzed as follows. Two out of three disks were irradiated three times for a period of 2 minutes using 340 nm light, while the third was not irradiated at all. One of the irradiated disks was then locked by exposing the entire disk matrix to radiation. All three disks were mechanically shaken for 3 days in 1.0 M NaCl solution. The NaCl solutions were then extracted by hexane and analyzed by ¹H-NMR. No peaks due to the RMC monomer were observed in the NMR spectrum. These results suggest that the RMC monomers did not leach out of the matrix into the aqueous phase in all three cases. Earlier studies on a vinyl endcapped silicone RMC monomer showed similar results even after being stored in 1.0 M NaCl solution for more than one year.

Matrix assisted laser desorption ionization time of flight (MALDI-TOF) mass spectrometry was employed to further study the potential leaching of monomer and matrix into aqueous solutions. Four lense disks were examined in this study. The first disk was fabricated with 30 and 10 wt % monomers E and F incorporated in 60 wt % of the PDMS matrix. This disk was exposed to 2.14 mW/cm² of 325 nm light from a He:Cd laser for four minutes after placing a 0.5 mm width astigmatism mask 23° clockwise from vertical over the lens. The first disk was then photolocked three

hours after the initial irradiation by exposure to a low pressure Hg lamp for 8 minutes. The second disk was composed of 30 and 10 wt % monomers B and D incorporated in 60 wt % of the PDMS matrix. This disk was exposed to 3.43 mW/cm² of 340 nm light from a Xe:Hg arc lamp after placing a 1 mm diameter photomask over the central portion of the disk. The second disk was not photolocked. The third disk was fabricated with 30 and 10 wt % monomers E and F incorporated in 60 wt % of the PDMS matrix. This disk was exposed to 2.14 mW/cm² of 325 nm light from a He:Cd laser for four minutes after placing a 1.0 mm diameter photomask over the central portion of the disk. The third disk was then photolocked three hours after the initial irradiation by exposure to a low pressure Hg lamp for 8 minutes. The fourth disk was fabricated with 30 and 10 wt % monomers E and F incorporated in 60 wt % of the PDMS matrix. The fourth disk was not irradiated. The four Tense disks were placed individually into 5 ml of doubly distilled water. One ml of dish washing detergent (a surfactant) was added to the solution containing lens #2. The disks were kept in their respective solutions for 83 days at room temperature. After this time, the lenses, in their respective solutions, were placed into an oven maintained at 37° C. for 78 days. Each of the aqueous solutions were then extracted three times using approximately 5 ml of hexane. All hexane extracts from each lens solution were combined, dried over anhydrous sodium sulfate (Na₂SO₄), and allowed to evaporate to dryness. Each of the four vials was then extracted with THF, spotted onto a dihydroxy benzoic acid matrix, and analyzed by MALDI-TOF. For comparison, each of the monomers and PDMS matrix were run in their pure form. Comparison of the four extracted lens samples and the pure components showed no presence of any of the monomers or matrix indicating that monomer and matrix were not leaching out of the disks.

### EXAMPLE 5

Irradiation of Silicone Prisms

Because of the ease of measuring refractive index change (Dn) and percent net refractive index change (%Dn) of prisms, the inventive formulations were molded into prisms 26 for irradiation and characterization, as shown in FIGS. 2a to 2d. As shown in FIG. 2a, the prisms 26 were fabricated by mixing and pouring (a) 90-60 wt % of high Mn PDMS 12 (FPMC), (b) 10-40 wt % of RMC 14 monomers in Table 2, and (c) 0.75 wt % (with respect to the RMC monomers) of the photoinitiator DMPA into glass molds in the form of prisms 5.0 cm long and 8.0 mm on each side. The silicone composition in the prisms 26 was moisture cured and stored in the dark at room temperature for a period of 7 days to ensure that the final matrix was non-tacky, clear, and transparent.

FIGS. 2a to 2d illustrate the prism irradiation procedure. Two of the long sides of each prism 26 were covered by a black background while the third was covered by a photomask 28 made of an aluminum plate 30 with rectangular windows 32 (2.5 mm×10 mm), as shown in FIG. 2b. Each prism 26 was exposed to 3.4 mW/cm² of collimated 340 nm light 16 (peak absorption of the photoinitiator) from a 1000 W Xe:Hg arc lamp for various time periods.

The prisms 26 with the photomask 28 were subject to both (i) continuous irradiation—one-time exposure for a known time period, and (ii) “staccato” irradiation—three shorter exposures with long intervals between them. During continuous irradiation, the refractive index contrast is dependent on the crosslinking density and the mole % phenyl groups, while in the interrupted irradiation; RMC 14 monomer diffusion and further crosslinking also play an important role. During staccato irradiation, the RMC 14 monomer polymerization depends on the rate of propagation during each exposure and the extent of interdiffusion of free RMC 14 monomer during the intervals between exposures. Typical values for the diffusion coefficient of oligomers (similar to the 1000 g/mole RMC 14 monomers used in the practice of the present invention) in a silicone matrix are on the order of 10⁻⁶ to 10⁻⁷ cm²/s. In other words, the inventive RMC 14 monomers require approximately 2.8 to 28 hours to diffuse 1 mm (roughly the half width of the irradiated bands). After the appropriate exposures, the prisms 26 were irradiated without the photomask (thus exposing the entire matrix) for 6 minutes using a medium pressure mercury-arc lamp, as shown in FIG. 2d. This polymerized the remaining silicone RMC 14 monomers and thus “locked” the refractive index of the prism in place.

### EXAMPLE 6

Prism Dose Response Curves

Inventive prisms 26 fabricated from RMC 14 monomers described by Table 2 were masked and initially exposed for 0.5, 1, 2, 5, and 10 minutes using 3.4 mW/cm² of the 340 nm line from a 1000 W Xe:Hg arc lamp, as shown schematically in FIGS. 2a to 2d. The exposed regions 20 of the prisms 26 were marked, the mask 28 detached and the refractive index changes measured. The refractive index modulation of the prisms 26 was measured by observing the deflection of a sheet of laser light passed through the prism 26. The difference in deflection of the beam passing through the exposed 20 and unexposed 22 regions was used to quantify the refractive index change (Dn) and the percentage change in the refractive index (% Dn).

After three hours, the prisms 26 were remasked with the windows 32 overlapping with the previously exposed regions 20 and irradiated a second time for 0.5, 1, 2, and 5 minutes (total time thus equaled 1, 2, 4, and 10 minutes respectively). The masks 28 were detached and the refractive index changes measured. After another three hours, the prisms were exposed a third time for 0.5, 1, and 2 minutes (total time thus equaled 1.5, 3, and 6 minutes) and the refractive index changes were measured. As expected, the % Dn increased with exposure time for each prism 26 after each exposure resulting in prototypical dose response curves. Based upon these results, adequate RMC 14 monomer diffusion appears to occur in about 3 hours for 1000 g/mole RMC 14 monomer.

All of the RMC monomers (B-F) except for RMC monomer A resulted in optically clear and transparent prisms before and after their respective exposures. For example, the largest % Dn for RMC monomers B, C, and D at 40 wt % incorporation into 60 wt % FPMC were 0.52%, 0.63% and 0.30% respectively which corresponded to 6 minutes of total exposure (three exposures of 2 minutes each separated by 3 hour intervals for RMC monomer B and 3 days for RMC monomers C and D). However, although it produced the largest change in refractive index (0.95%), the prism fabricated from RMC monomer A (also at 40 wt % incorporation into 60 wt % FPMC and 6 minutes of total exposure—three exposures of 2 minutes each separated by 3 hour intervals) turned somewhat cloudy. Thus, if RMC monomer A were used to fabricate a transparent optical data storage device, then the RMC must include less than 40 wt % of RMC monomer A or the % Dn must be kept below the point where the optical clarity of the material is compromised.

A comparison between the continuous and staccato irradiation for RMC A and C in the prisms shows that lower %Dn values occurs in prisms exposed to continuous irradiation as compared to those observed using staccato irradiations. As indicated by these results, the time interval between exposures (which is related to the amount of RMC diffusion from the unexposed to exposed regions) may be exploited to precisely modulate the refractive index of any material made from the inventive polymer compositions.

Exposure of the entire, previously irradiated prisms to a medium pressure Hg arc lamp polymerized any remaining free RMC, effectively locking the refractive index contrast. Measurement of the refractive index change before and after photolocking indicated no further modulation in the refractive index.

### EXAMPLE 7

Optical Characterization of Data Storage Elements

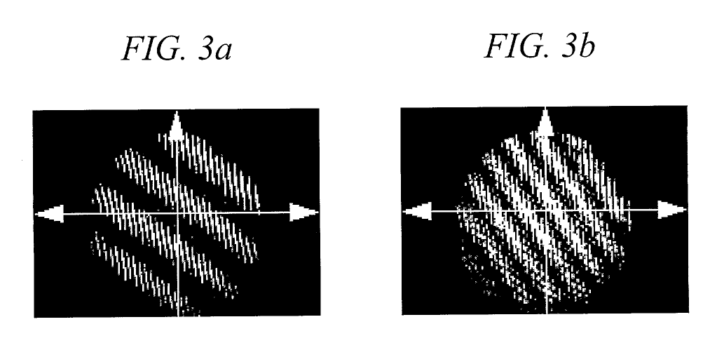

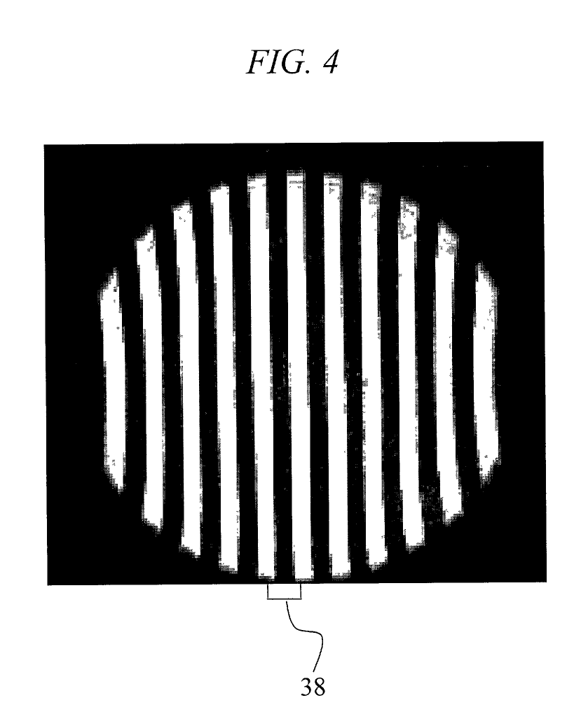

Talbot interferometry and the Ronchi test, as shown in FIGS. 3a, 3b and 4 were used to qualitatively and quantitatively measure any optical aberrations (primary spherical, coma, astigmatism, field curvature, and distortion) present in pre- and post-irradiated lense disks 10 as well as quantifying changes in power upon photopolymerization.

In Talbot interferometry, the test data storage element 10 is positioned between the two Ronchi rulings with the second grating placed outside the focus of the element and rotated at a known angle, q, with respect to the first grating. Superposition of the autoimage of the first Ronchi ruling (p₁=300 lines/inch) onto the second grating (P₂=150 lines/inch) produces Moiré fringes inclined at an angle, a₁. A second Moiré fringe pattern is constructed by axial displacement of the second Ronchi ruling along the optic axis a known distance, d, from the test element. Displacement of the second grating allows the autoimage of the first Ronchi ruling to increase in magnification causing the observed Moiré fringe pattern to rotate to a new angle, q₂. Knowledge of Moiré pitch angles permits determination of the focal length of the lens (or inversely its power) through the expression:

$$f = \frac{{p}_{1}}{{p}_{2}} {d ( \frac{1}{tan {α}_{2} sin θ + cos θ} - \frac{1}{tan {α}_{1} sin θ + cos θ} )}^{- 1} \qquad ( 1 )$$

To illustrate the applicability of Talbot interferometry to this work, Moiré fringe patterns of one of the inventive, pre-irradiated data storage elements (60 wt % PDMS, 30 wt % RMC monomer B, 10 wt % RMC monomer D, and 0.75% DMPA relative to the two RMC monomers) measured in air is presented in FIGS. 3a and 3b. Each of the Moiré fringes was fitted with a least squares fitting algorithm specifically designed for the processing of Moiré patterns. The angle between the two Ronchi rulings was set at 12°, the displacement between the second Ronchi ruling between the first and second Moiré fringe patterns was 4.92 mm, and the pitch angles of the Moiré fringes, measured relative to an orthogonal coordinate system defined by the optic axis of the instrument and crossing the two Ronchi rulings at 90°, were a₁=−33.2°±0.30° and a₂=−52.7°±0.40°. Substitution of these values into the above equation results in a focal length of 10.71±0.50 mm (power=93.77±4.6 D).

Optical aberrations of the inventive elements (from either fabrication or from the stimulus-induced polymerization of the RMC components) were monitored using the “Ronchi Test” which involves removing the second Ronchi ruling from the Talbot interferometer and observing the magnified autoimage of the first Ronchi ruling after passage through the test element. The aberrations of the test elements manifest themselves by the geometric distortion of the fringe system (produced by the Ronchi ruling) when viewed in the image plane. Knowledge of the distorted image reveals the aberration of the element. In general, the inventive fabricated elements (both pre and post irradiation treatments) exhibited sharp, parallel, periodic spacing of the interference fringes indicating an absence of the majority of primary-order optical aberrations, high optical surface quality, homogeneity of n in the bulk, and constant power. FIG. 4 is an illustrative example of a Ronchigram of an inventive, pre-irradiated element that was fabricated from 60 wt % PDMS, 30 wt % RMC monomer B, 10 wt % RMC monomer D, and 0.75% of DMPA relative to the 2 RMC monomers.

The use of a single Ronchi ruling may also be used to measure the degree of convergence of a refracted wavefront (i.e., the power). In this measurement, the test element is placed in contact with the first Ronchi ruling, collimated light is brought incident upon the Ronchi ruling, and the element and the magnified autoimage is projected onto an observation screen. Magnification of the autoimage enables measurement of the curvature of the refracted wavefront by measuring the spatial frequency of the projected fringe pattern. These statements are quantified by the following equation:

$${P}_{v} = \frac{1000}{L} ( 1 + \frac{{d}_{s}}{d} ) \qquad ( 2 )$$

wherein Pᵥ is the power of the element is expressed in diopters, L is the distance from the lens to the observing plane, d_{g}, is the magnified fringe spacing of the first Ronchi ruling, and d is the original grating spacing.

### EXAMPLE 8

Power Changes from Photopolymerization of the Inventive Data Storage Elements

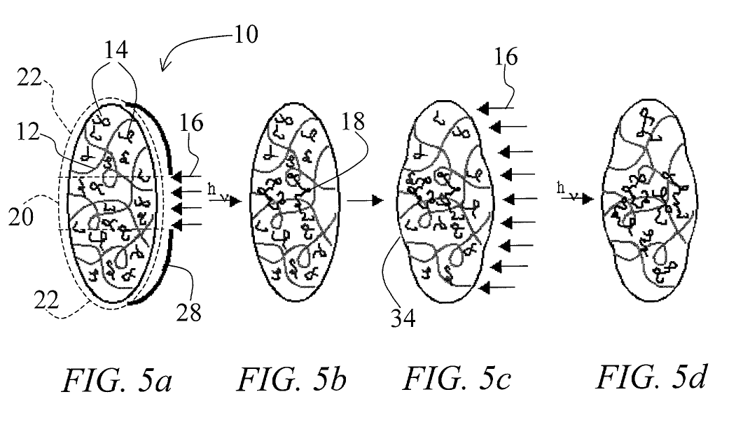

An inventive element 10 was fabricated as described by Example 3 comprising 60 wt % PDMS 12 (n_{D}=1.404), 30 wt % of RMC monomer B 14 (n_{D}=1.4319), 10 wt % of RMC monomer D 14 (n_{D}=1.4243), and 0.75 wt % of the photoinitiator DMPA relative to the combined weight percents of the two RMC 14 monomers. The data storage element 10 was fitted with a 1 mm diameter photomask 28 and exposed to 3.4 mW/cm² of 340 nm collimated light 16 from a 1000 W Xe:Hg arc lamp for two minutes, as shown in FIG. 5a. The irradiated data storage element 10 was then placed in the dark for three hours to permit polymerization and RMC 14 monomer diffusion, as shown in FIG. 5b. The data storage element 10 was photolocked by continuously exposing the entire element 10 for six minutes using the aforementioned light conditions, as shown in FIG. 5c. Measurement of the Moiré pitch angles followed by substitution into equation 1 resulted in a power of 95.1±2.9 D (f=10.52±0.32 mm) and 104.1±3.6 D (f=9.61 mm±0.32 mm) for the unirradiated 22 and irradiated 20 zones, respectively.

The magnitude of the power increase was more than what was predicted from the prism experiments where a 0.6% increase in the refractive index was routinely achieved. If a similar increase in the refractive index was achieved in the data storage element, then the expected change in the refractive index would be 1.4144 to 1.4229. Using the new refractive index (1.4229) in the calculation of the optical power (in air) and assuming the dimensions of the element did not change upon photopolymerization, an element power of 96.71 D (f=10.34 mm) was calculated. Since this value is less than the observed power of 104.1±3.6 D, the additional increase in power must be from another mechanism.

Further study of the photopolymerized element 10 showed that subsequent RMC 14 monomer diffusion after the initial radiation exposure leads to changes in the radius of curvature of the element 10, as shown in FIG. 5d. The RMC 14 monomer migration from the unirradiated zone 22 into the irradiated zone 20 causes either or both of the anterior 34 and posterior 36 surfaces of the element 10 to swell thus changing the radius of curvature of the element 10. It has been determined that a 7% decrease in the radius of curvature for both surfaces 34 and 36 is sufficient to explain the observed increase in optical power.

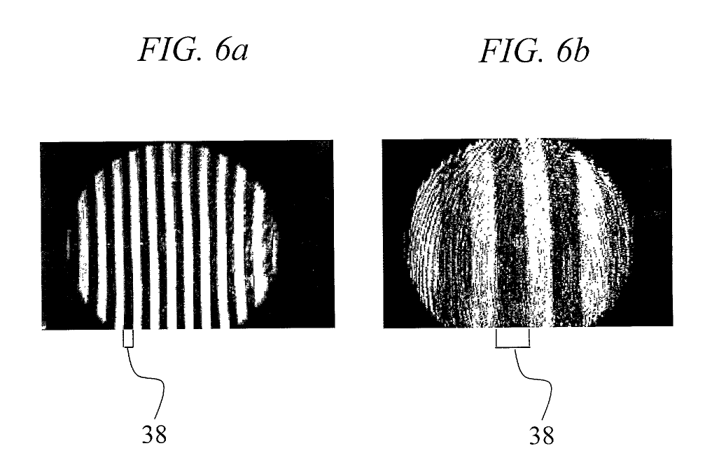

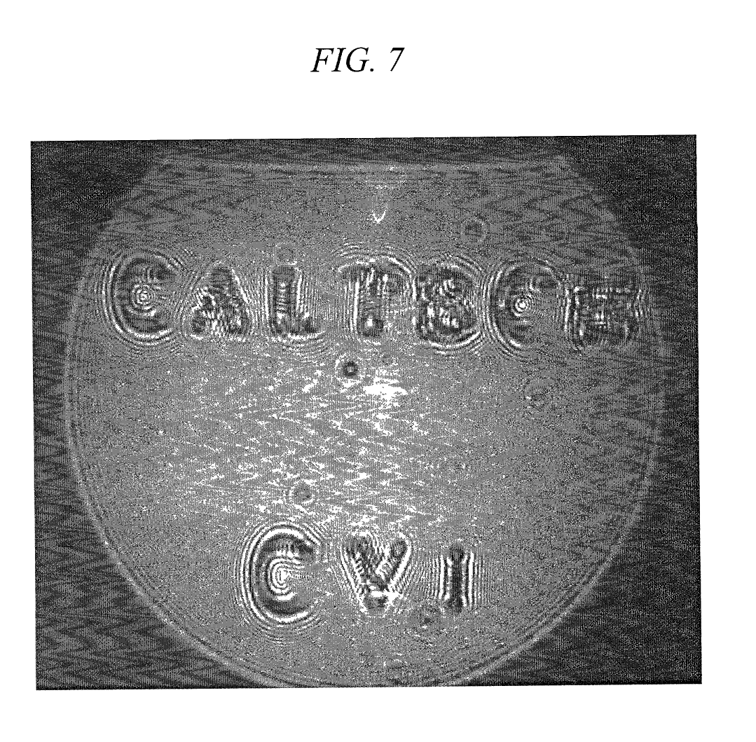

The concomitant change in the radius of curvature was further studied. An identical data storage element 10 described above was fabricated. A Ronchi interferogram of the element 10 is shown in FIG. 6a (left interferogram). Using a Talbot interferometer, the focal length of the element 10 was experimentally determined to be 10.52±0.30 mm (95.1 D±2.8 D). The element 10 was then fitted with a 1 mm photomask 28 and irradiated with 1.2 mW of 340 collimated light 16 from a 1000 W Xe:Hg arc lamp continuously for 2.5 minutes. Unlike the previous elements, this element 10 was not “locked in” three hours after irradiation. FIG. 6b (right interferogram) is the Ronchi interferogram of the element 10 taken six days after irradiation. The most obvious feature between the two interference patterns is the dramatic increase in the fringe spacing 38, which is indicative of an increase in the refractive power of the element 10. Measurement of the fringe spacings 38 indicates an increase of approximately +38 diopters in air (f>>7.5 mm). Indicating that this mechanism might be utilized in the system of the present invention.

### EXAMPLE 9

Photopolymerization Studies of Non-phenyl-containing Data Storage Elements

Inventive data storage elements 10 using non-phenyl containing RMC monomers 14 were fabricated to further study the swelling from the formation of the second polymer matrix 18. An illustrative example of such a data storage element 10 was fabricated from 60 wt % PDMS, 30 wt % RMC monomer E, 10 wt % RMC monomer F, and 0.75% DMPA relative to the two RMC monomers. The pre-irradiation focal length of the resulting element 10 was 10.76 mm±0.25 mm (92.94±2.21 D).

In this experiment, the light source 16 was a 325 nm laser line from a He:Cd laser. A 1 mm diameter photomask 28 was placed over the element 10 and exposed to a collimated flux 16 of 2.14 mW/cm² at 325 nm for a period of two minutes. The element 10 was then placed in the dark for three hours. Experimental measurements indicated that the focal length of the element 10 changed from 10.76 mm±0.25 mm (92.94 D±2.21 D) to 8.07 mm±0.74 mm (123.92 D±10.59 D) or a dioptric change of +30.98 D±10.82 D in air. The amount of irradiation required to induce these changes is only 0.257 J/cm².

### EXAMPLE 10

Monitoring for Potential Optical Changes from Ambient Light

The optical power and quality of the inventive data storage elements 10 were monitored to show that handling under ambient light conditions does not produce any unwanted changes in element. A 1 mm open diameter photomask was placed over the central region of an inventive element (containing 60 wt % PDMS, 30 wt % RMC monomer E, 10 wt % RMC monomer F, and 0.75 wt % DMPA relative to the two RMC monomers), exposed to continuous room light for a period of 96 hours, and the spatial frequency of the Ronchi patterns as well as the Moiré fringe angles were monitored every 24 hours. Using the method of Moiré fringes, the focal length measured in the air of the optical element immediately after removal from the optical element mold is 10.87±0.23 mm (92.00 D±1.98 D) and after 96 hours of exposure to ambient room light is 10.74 mm±0.25 mm (93.11 D±2.22 D). Thus, within the experimental uncertainty of the measurement, it is shown that ambient light does not induce any unwanted change in optical properties. A comparison of the resulting Ronchi patterns showed no change in spatial frequency or quality of the interference pattern, confirming that exposure to room light does not affect the power or quality of the inventive data storage elements 10.

### EXAMPLE 11

Effect of the Lock in Procedure of an Irradiated Data Storage Element

An inventive data storage element 10 whose optical properties had been modulated by irradiation was tested to see if the lock-in procedure resulted in further modification of element optical properties. A data storage element 10 fabricated from 60 wt % PDMS, 30 wt % RMC monomer E, 10 wt % RMC monomer F, and 0.75% DMPA relative to the two RMC monomers was irradiated for two minutes with 2.14 mW/cm² of the 325 nm laser line from a He:Cd laser and was exposed for eight minutes to a medium pressure Hg arc lamp. Comparisons of the Talbot images before and after the lock in procedure showed that the optical power of the element remained unchanged. The sharp contrast of the interference fringes indicated that the optical quality of the inventive element also remained unaffected.

To determine if the lock-procedure was complete, the IOL was refitted with a 1 mm diameter photomask and exposed a second time to 2.14 mW/cm² of the 325 nm laser line for two minutes. As before, no observable change in fringe space or in optical quality of the data storage element was observed.

### EXAMPLE 12

Monitoring for Potential Data Storage Element Changes from the Lock-in

A situation may arise wherein the data storage element does not require post-data storage modification. In such cases, the element must be locked in so that its characteristic will not be subject to change. To determine if the lock-in procedure induces undesired changes in the refractive power of a previously unirradiated data storage element, the inventive data storage element (containing 60 wt % PDMS, 30 wt % RMC monomer E, 10 wt % RMC monomer F, and 0.75 wt % DMPA relative to the two RMC monomers) was subject to three 2 minute irradiations over its entire area that was separated by a 3 hour interval using 2.14 mW/cm² of the 325 nm laser line from a He:Cd laser. Ronchigrams and Moiré fringe patterns were taken prior to and after each subsequent irradiation. The Moiré fringe patterns taken of the inventive data storage element in air immediately after removal from the mold and after the third 2 minute irradiation indicate a focal length of 10.50 mm±0.39 mm (95.24 D±3.69 D) and 10.12 mm±0.39 mm (93.28 D±3.53D) respectively. These measurements indicate that photolocking a previously unexposed element does not induce unwanted changes in optical properties. In addition, no discernable change in fringe spacing or quality of the Ronchi fringes was detected indicating that the refractive power had not changed due to the lock-in.

### EXAMPLE 13

### Phase Contrast Variation of a Composition Comprising a Refraction Modulating Composition

To examine the resolution (data density) of the photo-induced refractive materials composing the data storage elements, the following experiment was performed. Thin films of the photo-induced refractive composition were fabricated by first combining 60 wt % of diacetoxymethylsilyl endcapped polydimethylsiloxane (PDMS, M_{w}=36,000) matrix with 30 wt % methacryloxypropyldimethylsilyl endcapped polydimethylsiloxane (M_{w}=1,000) macromer, 10 wt % methacryloxypropyldimethylsilyl endcapped polydimethylsiloxane (M_{w}=4,000) macromer, and 0.75 wt % (relative to the two macromers) of the photoinitiator, 2,2-dimethoxy-2-phenylacetophenone (DMPA). The composition was mixed thoroughly at room temperature for 5 minutes and degassed at 30-mtorr pressure for 15 minutes to remove any entrapped air. The material was then placed between two glass slides and allowed to cure at room temperature for 24 hours.

The irradiation was carried out using the 325 nm line of a He:Cd laser. The beam emanating from the laser was focused down on to a 50 μm pinhole by a 75 mm focusing lens. A 125 mm lens was placed at a focal distance away from the pinhole to collimate the light producing a beam diameter of approximately 1.6 mm. Collimation of the beam was insured by monitoring the tilt angle of the fringes formed from a shearing plate interferometer placed in the beam.

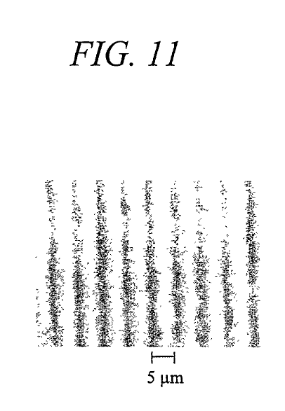

In one experiment, demonstrating the high resolution data storage capabilities of the inventive material, a 5000 lines/inch (a period of 5 μm) ruled grating was placed over the top surface of the sandwiched film and the photo-induced refractive composition was exposed to the Talbot autoimage of the grating using 6.57 mW/cm² of collimated 325 nm light for 90 seconds. FIG. 11 shows a microscope picture of the film after irradiation through the 5000 lines/inch mask. The magnification of the picture is approximately 125×. The alternating dark and light stripes running through the picture have a period of approximately 5 μm as determined by a calibrated microscope target. Therefore, the photoresponsive materials possess high spatial phase contrast. In this embodiment the composition of the current invention the exposed or stimulated region represents a digital “1” and the non-exposed or non-stimulated region represents a digital “0”.

In a second experiment, shown in FIG. 7, two sets of data were stored on a single photopolymer disk. First a 5000 lines/inch (a period of 5 μm) ruled grating was placed over the top surface of the sandwiched film and then a photomask having the words “CALTECH” and “CVI” was placed atop that. Then the photo-induced refractive composition was exposed to the Talbot autoimage of the grating and photomask using 6.57 mW/cm² of collimated 325 nm light for 90 seconds. As shown in FIG. 7, both the Ronchi rule and the words were inscribed on the photopolymer disk of the composition according to the present invention, this shows that patterns of any shape can be utilized to inscribe both high and low resolution data on the same disk of material simultaneously.

In this case, the incident light was orthogonal to the plane of the optical element (slab or lens) and data, in the form of the Ronchi rule was stored at only a single angle. It will be understood that data can be stored in the data storage composition 10 of the current invention more than once and at different angles. Such a multiple storage can be performed by tilting the slab by a certain angle and exposing it to UV-light through the ronchi ruling. When multiple data is stored by changing the angle, more lines appeared between the 5 micron lines shown in FIGS. 7 and 11, created by the multiple exposure to light. In addition, by keeping the incident light orthogonal to the plane of the slab, and rotating the slab by any angle, squares and other three-dimensional shapes can be formed into the data storage element 10.

The elements of the apparatus and the general features of the components are shown and described in relatively simplified and generally symbolic manner. Appropriate structural details and parameters for actual operation are available and known to those skilled in the art with respect to the conventional aspects of the process.

Although specific embodiments are disclosed herein, it is expected that persons skilled in the art can and will design alternative data storage elements and stat storage systems that are within the scope of the following claims either literally or under the Doctrine of Equivalents.

1. A method of recording data comprising:
providing a data storage composition comprising a first polymer matrix and a refraction modulating composition dispersed therein wherein the refraction modulating composition is capable of stimulus-induced polymerization; and
stimulating a region of the data storage composition, wherein the stimulated region of the composition and the non-stimulated region of the composition represent data.

2. The method of recording data as in claim 1 wherein the refraction modulating composition is capable of photo-induced polymerization.

3. The method of recording data as in claim 1 wherein the first polymer matrix is selected from the group consisting of poly-carbonates, acrylics, methacrylates, phosphazenes, siloxanes, vinyls, homopolymers, and copolymers thereof, and side chain and main chain mesogens, and photochromic and thermochromic moieties, and moieties which undergo a photo-induced cisitrans isomerization, such as, azo-benzene.

4. The method of recording data as in claim 1 wherein the refraction modulating composition includes a component selected from the group consisting of an acrylate, methacrylate, vinyl, siloxane, and phosphazene.

5. The method of recording data as described in claim 1 wherein the first polymer matrix includes a poly-siloxane.

6. The method of recording data as in claim 1 wherein the first polymer matrix includes a poly-acrylate.

7. The method of recording data as in claim 1 wherein the refraction modulating composition comprises a photoinitiator and a monomer of the formula:
X—Y—X¹
wherein Y is one of either: 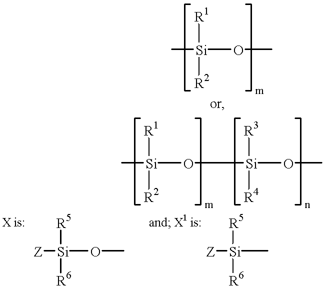
wherein m and n are each independently and integer and R¹, R², R³, R⁴, R⁵ and R⁶are each independently selected from the group consisting of hydrogen, alkyl, aryl and heteroaryl; and
wherein Z is a photopolymerizable group.

8. The method of recording data as in claim 7 wherein R¹, R², R³, R⁴, R⁵ and R⁶ are each independently a C₁-C₁₀ alkyl or phenyl, and Z is selected from the group consisting of acrylate, allyloxy, cinnamoyl, methacrylate, stibenyl and vinyl.

9. The method of recording data as in claim 7 wherein R¹, R², R³ and R⁵ and R⁶ are selected from the group consisting of methyl, ethyl and propyl and R⁴ is phenyl.

10. The method of recording data as in claim 7 wherein the monomer is selected from the group consisting of (i) dimethylsiloxane-diphenylsiloxane copolymer endcapped with a vinyldimethylsilane group, (ii) dimethylsiloxane-methylphenylsiloxane copolymer endcapped with a methacryloxypropyldimethylsilane group, and (iii) dimethylsiloxane encapped with a methacryloxypropyldimethylsilane group, and photoinitiator is 2,2-dimethoxy-2-phenylacetophenone.

11. The method of recording data as in claim 1 wherein the first polymer matrix is polydimethylsiloxane endcapped with diacetoxymethylsilane.

12. The method of recording data as in claim 1 wherein the data storage composition further comprises at least one photo-initiator.

13. The method of recording data as in claim 1 wherein the data storage composition is provided in a form selected from the group consisting of a disk, a CD or a DVD.

14. The method of recording data as in claim 1 wherein the data is stored in a format selected from the group consisting of digital, analog, or three-dimensional image.

15. The method of recording data as in claim 1 wherein the data is stored as either a reflective or volume hologram.

16. The method of recording data as in claim 1 wherein the stimulus is any wavelength incoherent or coherent source of light.

17. The method of recording data as in claim 1 wherein the stimulus is a UV light source.

18. The method of recording data as in claim 1 wherein the data storage composition is stable in ambient light.

19. The method of recording data as in claim 1 wherein the data storage composition is biocompatible.

20. The method of recording data as in claim 1 further comprising the steps of:
waiting an interval of time; and
stimulating or re-stimulating a region of the data storage composition to induce further polymerization of the refraction modulating composition.

21. The method of recording data as in claim 20 further comprising repeating the steps of waiting and re-stimulating.

22. The method of recording data as in claim 20 wherein the interval of time is determined by the time required for the diffusion of the refraction modulating composition and the volume shrinkage of the data composition to reach a null point.

23. The method of recording data as in claim 1 further comprising the step of locking-in the data by stimulating the entire data composition.

24. A composition for data storage comprising:
a first polymer matrix and a refraction modulating composition dispersed therein wherein the refraction modulating composition is capable of stimulus-induced polymerization, and wherein the stimulated region of the composition and the non-stimulated region of the composition represent data.

25. The composition as in claim 24 wherein the refraction modulating composition is capable of photo-induced polymerization.

26. The composition as in claim 24 wherein the first polymer matrix is selected from the group consisting of poly-carbonates, acrylics, methacrylates, phosphazenes, siloxanes, vinyls, homopolymers, and copolymers thereof, and side chain and main chain mesogens, and photochromic and thermochromic moieties, and moieties which undergo a photo-induced cis/trans isomerization, such as, azo-benzene.

27. The composition as in claim 24 wherein the refraction modulating composition includes a component selected from the group consisting of an acrylate, methacrylate, vinyl, siloxane, and phosphazene.

28. The composition as described in claim 24 wherein the first polymer matrix includes a poly-siloxane.

29. The composition as in claim 24 wherein the first polymer matrix includes a poly-acrylate.

30. The method of recording data as in claim 24 wherein the refraction modulating composition comprises a photoinitiator and a monomer of the formula:
X—Y—X¹
wherein Y is one of either: 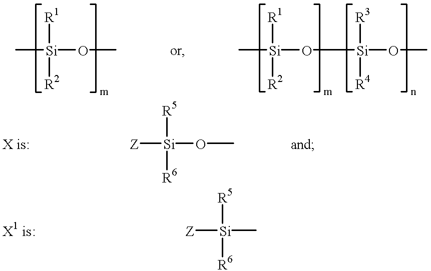
wherein m and n are each independently and integer and R¹, R², R³, R⁴, R⁵ and R⁶ are each independently selected from the group consisting of hydrogen, alkyl, aryl and heteroaryl; and
wherein Z is a photopolymerizable group.

31. The composition as in claim 30 wherein R¹, R², R³, R⁴, R⁵ and R⁶ are each independently a C₁-C₁₀ alkyl or phenyl, and Z is selected from the group consisting of acrylate, allyloxy, cinnamoyl, methacrylate, stibenyl and vinyl.

32. The composition as in claim 30 wherein R¹, R², R³ and R⁵ and R⁶ are selected from the group consisting of methyl, ethyl and propyl and R⁴ is phenyl.

33. The composition as in claim 30 wherein the monomer is selected from the group consisting of (i) dimethylsiloxane-diphenylsiloxane copolymer endcapped with a vinyldimethylsilane group, (ii) dimethylsiloxane-methylphenylsiloxane copolymer endcapped with a methacryloxypropyldimethylsilane group, and (iii) dimethylsiloxane encapped with a methacryloxypropyldimethylsilane group, and photoinitiator is 2,2-dimethoxy-2-phenylacetophenone.

34. The composition as in claim 24 wherein the first polymer matrix is polydimethylsiloxane endcapped with diacetoxymethylsilane.

35. The composition as described in claim 24 wherein the first polymer matrix includes a poly-siloxane.

36. The method of recording data as in claim 24 wherein the data storage composition further comprises at least one photo-initiator.

37. The method of recording data as in claim 24 wherein the data storage composition is stable in ambient light.

38. The method of recording data as in claim 24 wherein the data storage composition is biocompatible.

39. A data storage device comprising:
a data storage unit having a data storage composition disposed therein, the data storage composition comprising a first polymer matrix and a refraction modulating composition dispersed therein wherein the refraction modulating composition is capable of stimulus-induced polymerization, and wherein the stimulated region of the composition and the non-stimulated region of the composition represent data;
a stimulus generator for generating a stimulus in signal communication with the composition; and
an analyzer for analyzing the data stored on the data storage composition.

40. The data storage device as in claim 39 wherein the refraction modulating composition is capable of photo-induced polymerization.

41. The data storage device as in claim 39 wherein the first polymer matrix is selected from the group consisting of poly-carbonates, acrylics, methacrylates, phosphazenes, siloxanes, vinyls, homopolymers, and copolymers thereof, and side chain and main chain mesogens, and photochromic and thermochromic moieties, and moieties which undergo a photo-induced cis/trans isomerization, such as, azo-benzene.

42. The data storage device as in claim 39 wherein the refraction modulating composition includes a component selected from the group consisting of an acrylate, methacrylate, vinyl, siloxane, and phosphazene.

43. The data storage device as described in claim 39 wherein the first polymer matrix includes a poly-siloxane.

44. The method of recording data as in claim 39 wherein the refraction modulating composition comprises a photoinitiator and a monomer of the formula:
X—Y—X¹
wherein Y is one of either: 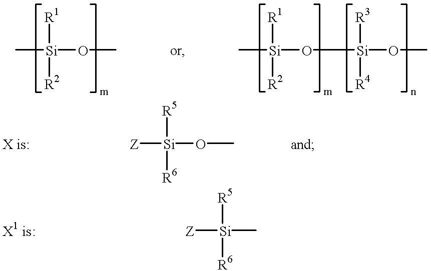
wherein m and n are each independently and integer and R¹, R², R³, R⁴, R⁵ and R⁶ are each independently selected from the group consisting of hydrogen, alkyl, aryl and heteroaryl; and
wherein Z is a photopolymerizable group.

45. The data storage device as in claim 44 wherein R¹, R², R³, R⁴, R⁵ and R⁶ are each independently a C₁-C₁₀ alkyl or phenyl, and Z is selected from the group consisting of acrylate, allyloxy, cinnamoyl, methacrylate, stibenyl and vinyl.

46. The data storage device as in claim 44 wherein R¹, R², R³ and R⁵ and R⁶ are selected from the group consisting of methyl, ethyl and propyl and R⁴ is phenyl.

47. The data storage device as in claim 44 wherein the monomer is selected from the group consisting of (i) dimethylsiloxane-diphenylsiloxane copolymer endcapped with a vinyldimethylsilane group, (ii) dimethylsiloxane-methylphenylsiloxane copolymer endcapped with a methacryloxypropyldimethylsilane group, and (iii) dimethylsiloxane encapped with a methacryloxypropyldimethylsilane group, and photoinitiator is 2,2-dimethoxy-2-phenylacetophenone.

48. The data storage device as in claim 39 wherein the first polymer matrix is polydimethylsiloxane endcapped with diacetoxymethylsilane.

49. The data storage device as in claim 39 wherein the data storage composition further comprises at least one photo-initiator.

50. The data storage device as in claim 39 wherein the data storage unit is selected from the group consisting of a disk, a CD or a DVD.

51. The data storage device as in claim 39 wherein the data storage unit is flexible.

52. The data storage device as in claim 39 wherein the data is stored in a format selected from the group consisting of digital, analog, or three-dimensional image.

53. The data storage device as in claim 39 wherein the data is stored as either a reflective or volume hologram.

54. The data storage device as in claim 39 wherein the data is stored in either a high or low resolution format.

55. The data storage device as in claim 39 wherein the data is stored in both a high and low resolution format.

56. The data storage device as in claim 39 wherein the stimulus generator is any wavelength incoherent or coherent source of light.

57. The data storage device as in claim 39 wherein the stimulus generator is a light source.

58. The data storage device as in claim 39 wherein the stimulus generator both writes and reads the data.

59. The data storage device as in claim 58 wherein the stimulus generator utilizes a single wavelength to both write and read the data.

60. The method of recording data as in claim 39 wherein the data storage composition is stable in ambient light.

61. The method of recording data as in claim 39 wherein the data storage composition is biocompatible.

62. A data storage unit comprising:
two transparent electrically conducting electrodes; and
a first polymer matrix and a refraction modulating composition dispersed therebetween wherein the refraction modulating composition is capable of stimulus-induced polymerization, wherein the stimulated region of the composition and the non-stimulated region of the composition represent data.

63. A data storage unit as in claim 62 wherein the data storage unit is flexible.

64. A data storage unit comprising:
a substrate having a tracking layer disposed thereon;
a transparent protective coating layer; and
a first polymer matrix and a refraction modulating composition dispersed therebetween wherein the refraction modulating composition is capable of stimulus-induced polymerization, wherein the stimulated region of the composition and the non-stimulated region of the composition represent data.

65. A data storage unit as in claim 64 wherein the data storage unit is flexible.
